(19) United States
(12) Patent Application Publication
(10) Pub. No.: US 2026/0162384 A1
(43) Pub. Date: Jun. 11, 2026

(54) IMMERSIVE SCENE NAVIGATION USING PORTAL

(71) Applicant: Lowe's Companies, Inc., Mooresville, NC (US)

(72) Inventors: Deane McGahan, Shoreline, WA (US); Philip Ashton Harlow, Bothell, WA (US)

(21) Appl. No.: 19/411,856

(22) Filed: Dec. 8, 2025

Related U.S. Application Data
(60) Provisional application No. 63/730,348, filed on Dec. 10, 2024.

(51) Int. Cl. G06T 19/00; G06F 3/01

(52) U.S. Cl. CPC G06T 19/006; G06F 3/017; G06T 19/003

(57) ABSTRACT

Techniques configured to present, a virtual representation of a virtual object from a first virtual location of a first mixed reality (MR) scene. The techniques further configured to present a user interface element enabling changing between virtual locations within the first MR scene; receive a first selection of the user interface element; and responsive to the selection, present a set of virtual locations identifiers within the first MR scene. The techniques further configured to receive a second selection of a second virtual location identifier selected from the set of virtual location identifiers; present, using a portal object, the virtual object from a second virtual location identified by the second virtual location identifier; receive an indication of an interaction with the portal object that indicates the portal object is selected; and present the first MR scene viewed from the second virtual location and showing the virtual object.

### CROSS-REFERENCES TO RELATED APPLICATIONS

This application claims the benefit of U.S. Provisional Patent Application No. 63/730,348, filed Dec. 10, 2024, the entire contents of which are hereby incorporated by reference for all purposes in their entirety.

### BACKGROUND

Rendering objects for display in mixed reality (MR) (e.g., augmented reality environments, virtual reality environments, and/or spatial computing environments) can be useful for applications in the physical world. For example, mixed reality models (e.g., virtual model of a kitchen including countertops, cabinets, appliances, etc.) of physical environments can be displayed in a MR environment. Viewing and editing a virtual model in a MR environment can help a user visualize how edits to the virtual model will affect an appearance of the installed/constructed physical objects in the environment. Conventional user interfaces may not be as effective in a MR environment where a user has increased spatial computing ability.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present disclosure describes techniques for providing, by a virtual rendering system to a user device, a MR view of a MR model.

Embodiments of the present invention may allow for the mapping of MR scenes to one or more windows of a multi-dimensional portal object, the presentation of the MR scenes to a user via the one or more windows, and the capability for a user to interact with the MR scenes and the multi-dimensional portal.

Certain embodiments of the invention comprises a user device, the user device comprising one or more processors and one or more memory storing instructions that, upon execution by the one or more processors, configure the user device to present, a virtual representation of a virtual object from a first virtual location of a first mixed reality (MR) scene. The instructions further configuring the user device to present a user interface element to enable changing between virtual locations within the first MR scene. The instructions further configuring the user device to receive a first selection of the user interface element. The instructions further configuring the user device to responsive to the first selection, present a set of virtual locations identifiers within the first MR scene that the first MR scene is configured to present a view from and that includes a second virtual location identifier. The instructions further configuring the user device to receive a second selection of the second virtual location identifier selected from the set of virtual location identifiers. The instructions further configuring the user device to present, using a portal object, the virtual object from a second virtual location identified by the second virtual location identifier. The instructions further configuring the user device to receive an indication of an interaction with the portal object that indicates the portal object is selected. The instructions further configuring the user device to present a second MR scene viewed from the second virtual location and showing the virtual object.

Certain embodiments include techniques (e.g., a computer readable medium, a system, a user device, a method, etc.) that present, a virtual representation of a virtual object from a first virtual location of a first mixed reality (MR) scene. The techniques can present a user interface element to enable changing between virtual locations within the first MR scene. The techniques can receive a first selection of the user interface element. The techniques can, responsive to the first selection, present a set of virtual locations identifiers within the first MR scene that the first MR scene is configured to present a first view from and that includes a second virtual location identifier. The techniques can receive a second selection of the second virtual location identifier selected from the set of virtual location identifiers. The techniques can present, using a portal object, the virtual object from a second virtual location identified by the second virtual location identifier. The techniques can receive an indication of an interaction with the portal object that indicates the portal object is selected. The techniques can present the first MR scene viewed from the second virtual location and showing the virtual object.

In certain embodiments, presenting the first MR scene viewed from the second virtual location includes presenting a second MR scene that is generated based on the first MR scene.

In certain embodiments, the first virtual location and the second virtual location are viewed from a common physical location of a user device.

In certain embodiments, receiving the indication of the interaction with the portal object is based at least in part on a user device detecting a reverse pinching gesture.

In certain embodiments, the portal object includes a first window that presents the virtual object from the second virtual location and a second window that presents the virtual object from a third virtual location.

In certain embodiments, receiving the indication of the interaction with the portal object configures a user device to receive a second indication of a second interaction with the first window.

In certain embodiments, the techniques can present a second user interface element to enable changing between virtual locations within the first MR scene. In certain embodiments, the techniques can receive a third selection of the second user interface element. In certain embodiments, the techniques can responsive to the third selection, present a second set of virtual locations identifiers within the first MR scene that the first MR scene is configured to present a second view from and that includes a third virtual location identifier. In certain embodiments, the techniques can receive a fourth selection of the third virtual location identifier selected from the second set of virtual location identifiers. In certain embodiments, the techniques can present, using a second portal object, the virtual object from a third virtual location identified by the third virtual location identifier. In certain embodiments, the techniques can receive a second indication of a second interaction with the second portal object that indicates the second portal object is selected. In certain embodiments, the techniques can present the first MR scene viewed from the third virtual location and showing the virtual object.

In certain embodiments, the techniques can present a second user interface element to enable changing between virtual locations within the first MR scene. In certain embodiments, the techniques can receive a third selection of the second user interface element. In certain embodiments, the techniques can present the first MR scene viewed from the first virtual location and showing the virtual object.

In certain embodiments, the techniques can, responsive to detecting, using a camera, a gesture: present the first MR scene viewed from the first virtual location and showing the virtual object.

In certain embodiments, the techniques can receive, after presenting the first MR scene viewed from the second virtual location, a second indication to change a visual property of the first MR scene. In certain embodiments, the techniques can, after the second indication, present the first MR scene viewed from the first virtual location and showing the change to the visual property of the first MR scene.

These and other embodiments are described in further detail below.

### BRIEF DESCRIPTION OF THE DRAWINGS

FIG. 1 illustrates a system, according to certain embodiments disclosed herein.

FIG. 2 illustrates an example of a MR scene viewed from a first virtual location that may be presented by a user device.

FIG. 3 illustrates an example of a user interface that may be presented before using a teleport scene navigation feature.

FIG. 4 illustrates an example of a portal object including a window that may be presented by a user device.

FIG. 5 illustrates an example of a MR scene viewed from a second virtual location that may be presented by a user device.

FIG. 6 illustrates a method of interacting with a portal object window, according to certain embodiments disclosed herein.

FIG. 7 depicts further details of the computing environment of FIG. 1, according to certain embodiments disclosed herein.

FIG. 8 depicts an example of a computing system that performs certain operations described herein, according to certain embodiments described in the present disclosure.

FIG. 9 depicts an example of a cloud computing system that performs certain operations described herein, according to certain embodiments described in the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

With reference to the embodiments described herein, a computing environment may include a rendering system, which can include a number of computing devices, rendering applications, and a data store. The rendering system may be configured to render a MR model of a physical environment (e.g., a virtual model of a kitchen, a compact AR model of a bedroom). The virtual model includes virtual objects corresponding to existing physical objects and an arrangement of the virtual objects. The MR model of the data store can be presented in a computer-based simulated environment, such as in a virtual reality environment and/or an augmented reality environment.

Embodiments include methods and systems for presenting and interacting with MR scenes, windows, and portals.

Embodiments may allow for a portal object (e.g., a multi-dimensional portal object) to be presented on a display by a user device. The portal object may be presented while a first immersive MR scene is being displayed by the user device. In the present disclosure, the portal object is described as a two-dimensional portal object including a single window as an example. However, the portal object is not limited to two dimensions or one window. The portal object may show any number of windows and each window may be mapped to any number of corresponding MR scenes. A user of the user device may be able to view at least a portion of a second MR scene from a virtual viewing location shown within a window by interacting with the portal object to orient the portal object such that the window is in view and shows the portion of the second MR scene. The user may have a virtual viewing location from the outside of the second MR scene as if looking into the second MR scene through the window. The second MR scene viewed through the window can show an MR scene that corresponds to (e.g., is a copy of, is the same scene as) the first MR scene the user is immersed in. The second MR scene may show the same objects included in the first MR scene but from a different virtual location relative to the objects.

In some embodiments, the portal object may be capable of being interacted with by a user action, such as rotating the portal object or enlarging the portal object. In some embodiments, after the user interaction with the portal object, different portions of the portal object may be presented by the user device and cause certain windows, certain MR scenes from certain virtual viewing locations to be presented by the user device.

In an embodiment, the user can resize the portal object, windows, and/or MR scenes by performing a second action. The second action may cause the user device to present additional portions of a MR scene. In an embodiment, the user can be presented with the MR scene in an immersive fashion such that they can look around the MR scene and have a virtual viewing location from within the MR scene.

Some terms used throughout the application may be defined as follows.

“Mixed Reality” may refer to augmented reality, virtual reality, spatial computing, or any combination thereof. A virtual reality, or “VR,” scenario typically involves presentation of digital or virtual image information without transparency to other actual real-world visual input. An augmented reality, or “AR,” scenario typically involves presentation of digital or virtual image information as an augmentation to visualization of the actual world around the user. A spatial computing scenario typically involves integrating user interfaces into a physical environment (e.g., objects, spaces). A device used for mixed reality application may be capable of presenting MR models (e.g., AR models, VR models, etc.).

A “user device” may be used by a user of the device. A user device may be capable of running mixed reality applications. A user device may include various sensors, such as any number of and any combination of: eye tracking sensors, gesture recognition sensors, microphones, LiDAR scanners, cameras (e.g., IR cameras), accelerometers, gyroscopes. A user device may also include other hardware such as one or more speakers, dials, fans, buttons, batteries, displays, IR illuminators, LEDs, electric motors (e.g., for vibrations), etc. Examples of user devices may be phones, tablet, headsets, smart glasses, etc.

A “portal object” may be a virtual object viewed using a user device and generated by an application running on the user device and/or remote to the user device. A portal object may be a multi-dimensional object and may have any number of surfaces, edges, and vertices. A portal object may have any number of dimensions. Examples of portal objects may be a two-dimensional plane or a three-dimensional object (e.g., a sphere, pyramid, prism, torus, etc.). A portal object may have one or more windows associated with it. Each surface of a portal object may have any number of windows associated with it.

A “window” may allow for a user to view a MR scene while using a user device. A window may allow the user to view a MR scene at different angles depending on the orientation of the window with respect to the user. A window may be associated with one or more surfaces of a portal object. In an example, a window is associated with and appears as at least a portion of a surface of a portal object. A user may be able to interact with a window to allow the user to view more or less of a MR scene that is capable of being viewed through the window. Windows may define the shape of a portal object and/or may be placed on a surface of a portal object. Thus, when it is described that a portal object includes windows on surfaces or that a window is associated with a surface of a portal object, either implementation or a combination thereof may be used. A window may be moved through to cause the MR scene at a first virtual location to be presented within the window to become an immersive MR scene. The MR scene and/or the virtual location may be different than a current immersive MR scene the window is presented in. A window may be exited to cause a previous immersive MR scene to be presented from a previous virtual location within the previous immersive MR scene.

A “MR scene” may be a visual representation of a particular virtual setting. A MR scene may be three-dimensional. A MR scene may comprise any number of virtual objects. Virtual objects may be three-dimensional objects placed in a MR scene (e.g., a virtual chain, virtual flooring, virtual sink, etc.). A user may be able to view different portions of a MR scene by moving parts of their body (e.g., walking, turning around, moving their head, moving their hands, etc.). A user may be able to view different portions of a MR scene by interacting with portal objects and/or windows (e.g., without physically moving). A user may be able to view a portion of a MR scene or may be able to view an entire MR scene. In an example, a user may use a user device running a MR application to look at a portal object, a surface of the portal object may be associated with a window that is associated with (“mapped” to) a MR scene, the user may be capable of viewing at least a portion of the MR scene from a virtual location by looking at the window. A MR scene may be akin to looking through a window to a space (e.g., looking at a kitchen through a window).

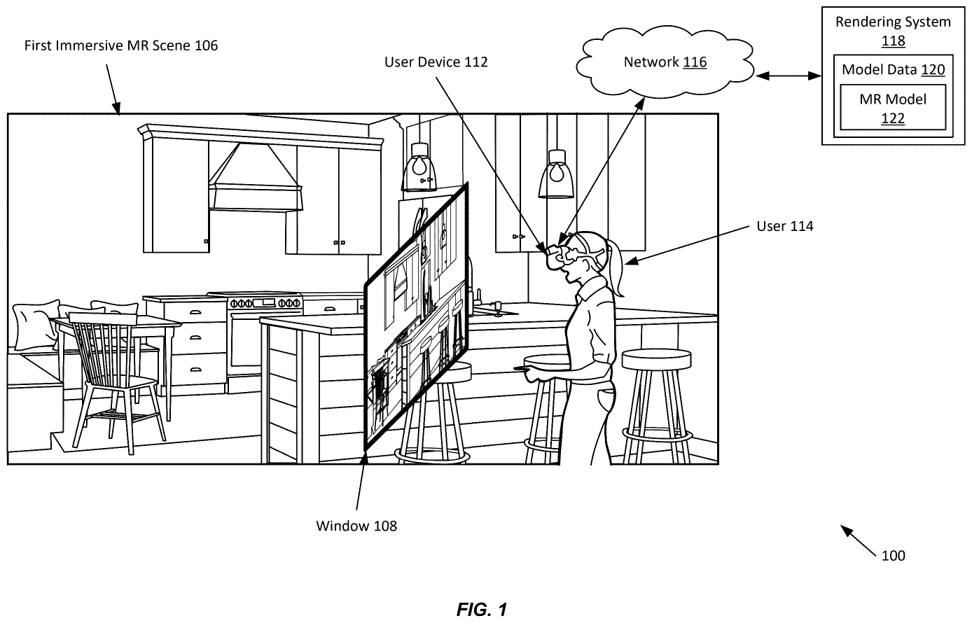

FIG. 1 illustrates a system, according to certain embodiments disclosed herein. FIG. 1 depicts an example of a computing system 100 for providing, by a rendering system 118 via a user device 112, a view of a MR model 122 (e.g., a virtual model) in an MR environment, according to certain embodiments disclosed herein.

The rendering system 118 can include one or more processing devices that execute one or more rendering applications. In certain embodiments, the rendering system 118 includes a network server and/or one or more computing devices communicatively coupled via a network 116. The rendering system 118 may be implemented using software (e.g., code, instructions, program) executed by one or more processing units (e.g., processors, cores), hardware, or combinations thereof. The software may be stored on a non-transitory storage medium (e.g., on a memory device). The computing environment 100 is merely an example and is not intended to unduly limit the scope of claimed embodiments. Based on the present disclosure, one of the ordinary skill in the art would recognize many possible variations, alternatives, and modifications. In some instances, the rendering system 118 provides a service that enables display of virtual objects in an MR environment for users 114, for example, including a user 114 associated with a user device 112. In the example depicted in computing environment 100, a user device 112 displays, in an MR session, a MR model 122 within a field of view of the user device 112. As shown in computing environment 100, the MR model 122 is displayed in a field of view. In some cases, the MR model 122 may be displayed in a portion of the field of view and one or more physical objects may be displayed in another portion of the field of view. In some instances, the MR model 122 (e.g., a virtual model) is overlayed on one or more physical objects so that it occludes the one or more overlayed physical objects.

In some embodiments, the MR model 122 may be anchored to a point in a three-dimensional coordinate space based on actions of a user 114, the area of the physical space the user 114 is in, and/or a predetermined anchor point.

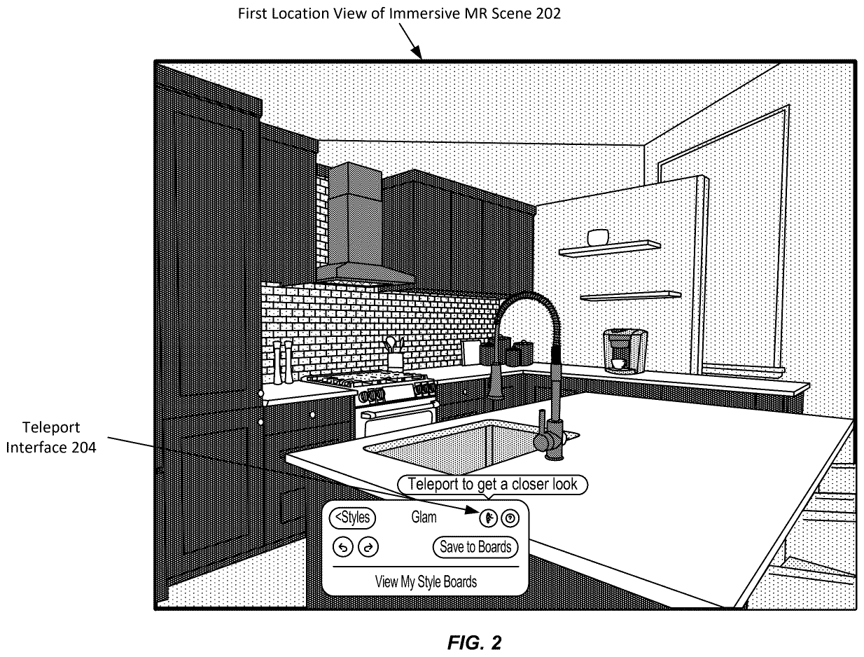

The MR model 122 may comprise a portal object. The portal object may be presented in one or more orientations. In an embodiment, a user 114 can interact with the portal object by using gestures (e.g., pinching, pointing, moving their eyes, clicking, moving their body, etc.). Upon the user device 112 detecting a user 114 interaction, action data may be generated by the user device 112 that describes the user 114 interaction that was detected. The action data may be used by the user device 112 to control the presentation of UI elements (e.g., the portal object, windows, MR scenes, a user interface) and/or the functionality of the presented UI elements (e.g., turning the portal object, enlarging a window of the portal object, entering an immersive MR scene, exiting an immersive MR scene, transitioning between immersive MR scenes). In an embodiment, when the user 114 interacts with the portal object, generated action data may cause a virtual location of the user device 112 within the immersive MR scene 106 to change. The change in location may be indicated by presenting on a display of the user device, animations that show window 108 being moved toward (e.g., such that is virtually moved through). A further description of the interactions that are possible with the window 108 are described below (e.g., with respect to FIGS. 2-5).

The portal object may show an arrangement of windows and MR scenes. In an embodiment, each surface of the portal object may comprise any number of windows (e.g., zero or more). A window may make up at least a portion of a surface of the portal object. Each window may be mapped to any number of MR scenes (e.g., zero or more). As an example, using exemplary computing system 100, the MR model 122 may represent a portal object, the portal object may comprise a planar portal object such as a rectangle. A surface of the portal object may show a window that visually takes up the entire surface of the rectangular plane. In the example shown in computing system 100, the window 108 may take up the entirety of a surface of the portal object the window 108 is associated with. Further, the window 108 may be mapped to a MR scene that the user 114 is able to see when they are looking at the window that is mapped to the MR scene. The window 108 may be mapped to a virtual location that the MR scene is to be viewed from. The MR scene may be the same scene as the immersive MR scene 106 presented by user device 112 but may be shown from a different virtual location (e.g., a virtual location behind a virtual counter object included in the immersive MR scene). Thus, as the user 114 looks at window 108, they may be able to see at least a portion of a first MR scene that is mapped to window 108.

In certain embodiments, the portal object includes window 108 and one or more other windows, and as the user 114 looks at a second window they may be able to see at least a portion of a second MR scene or yet another different virtual location of the immersive MR scene that is mapped to the second window. Therefore, as the orientation of the rectangular prism changes with respect to the user 114, the user 114 may be able to see different windows of the rectangular prism and therefore may be able to view different MR scenes or portions of MR scenes.

In some embodiments, the MR model 122 may comprise at least a portion of a MR scene. In certain embodiments, the user 114 may be immersed in the MR scene so that they may look around the MR scene. The MR scene may be representative of a room the user 114 is located in, another room associated with the user 114, or be based on another real or theoretical room (e.g., a room created by a design team in a digital environment, a room of another user).

In an example, the virtual viewing location (e.g., virtual viewing location of the portal object and/or of an MR scene) of the user device 112 is determined and matched to a location of the room the user 114 is in. In an example, the virtual viewing location (e.g., virtual viewing location of the portal object and/or of an MR scene) of the user device 112 is determined based on a window that was entered into by a user after the window was presented to the user and a selection of the window was indicated. In an example, the virtual viewing location (e.g., virtual viewing location of the portal object and/or of an MR scene) of the user device 112 is determined based on a window that was exited out of by a user after the window was presented to the user and a selection of the window was indicated.

Although the user device 112 is depicted as being a wearable device, the user device 112 could be other devices other than a wearable user device 112. For example, the user device 112 could be a smart phone device, a tablet device, or other user device 112. Further, in some embodiments, more than one user device 112 may be capable of viewing and/or interacting with the same portal object.

In some embodiments, as depicted in computing system 100, the user device 112 communicates via the network 116 with a rendering system 118, which renders model data 120 defined by the MR model 122. The model data 120 may also define a compact AR model or another type of MR model 122 associated with the MR model 122. Examples of compact AR models that may be adapted for use with the inventive subject matter are described in U.S. patent application Ser. No. 18/082,952 to Mcgahan titled “Compact Augmented Reality View Experience,” filed Dec. 16, 2022, the content of which is incorporated herein by reference in its entirety. A compact AR model may cause model objects to be overlayed over existing physical objects in a physical environment of the user device 112 and leaves a portion of existing physical objects in the field of view visible to the user 114 through the user device 112. In an embodiment, a MR scene objects included in a compact AR model can represent a subset of MR scene objects included in a corresponding VR model.

In some instances, multiple compact AR models are associated with a single virtual model. In other embodiments, the user device 112 comprises the rendering system 118 and the user device 112 can perform all the processing described herein as being performed by the rendering system 118 on the user device 112 without needing to communicate via the network 116.

What is presented by the user device 112 may be changed according to what MR scene is currently the immersive MR scene and/or what actions the user 114 performs. In an example, the user 114 may make a spreading (e.g., zooming) motion with their fingers, and as the user's 114 fingers become more spread apart, window 108 may become larger and larger. In an embodiment, after window 108 becomes a certain size, the other window 108 of the portal object may no longer be shown by the user device 112. For example, once the user 114 has enlarged window 108 past a certain threshold point, the other surfaces of the portal object may no longer be presented by the user device 112. In an embodiment, as the window becomes larger, additional portions of the MR scene associated with the window are shown by the user device 112 (e.g., the user 114 may be able to see a third MR scene object (e.g., a 3D chair object, table object) that was previously out of view once the window is enlarged past a certain point).

Once a window becomes large enough, a first portion of the MR scene may be presented to the user 114 in an immersive MR scene. The immersive MR scene 106 may correspond to a virtual viewing location and to the MR scene mapped to window 108. The immersive MR scene 106 may behave as a MR experience according to the objects in the immersive MR scene 106. A user 114 may be capable of using one or more actions (e.g., moving their body, interacting with a controller) to cause different portions of the immersive MR scene 106 to be shown by the user device 112. For example, a user 114 may cause the viewpoint anchor to change so that different portions of the immersive MR scene 106 can be presented (e.g., by walking around the immersive MR scene 106, enlarging objects).

The immersive MR scene 106 is shown in a field of view. In some cases, the immersive MR scene 106 may be shown in a portion of the field of view and one or more physical objects may be shown in another portion of the field of view. In some instances, the immersive MR scene 106 is overlayed on one or more physical objects so that it occludes the one or more overlayed physical objects.

In an embodiment, when an immersive MR scene 106 is being presented by the user device 112, particular sounds and/or vibrations may be output by the user device 112 that correspond to the immersive MR scene 106 and/or events occurring within the immersive MR scene 106.

In an embodiment, the user 114 may be capable of causing one or more objects of the immersive MR scene 106 to change. For example, the user 114 may perform an action with respect to a first object within the immersive MR scene 106 to cause the object to be added, removed, appearance changed (shape, color, texture, label), repositioned, etc.

In an embodiment, when the user alters a MR scene, while immersed in the scene or not, (e.g., by adding an object, removing an object, changing an appearance of an MR scene object, changing a MR scene style, repositioning an MR scene object, etc.), a new scene is generated and associated with a new or existing window for the portal object. In an embodiment, when the user 114 alters a MR scene, the MR scene is altered and the alteration is reflected in the MR scene subsequently (e.g., when the user 114 viewed the MR scene through the mapped window 108 of the portal object, when the user 114 is presented with an immersive view of the MR scene).

The user 114 may be able to perform another action (e., selecting a UI element, pressing a button, performing a body movement), which may cause the presentation of immersive MR scene 106 to be dismissed/exited. In an embodiment, when the immersive MR scene 106 is dismissed/exited, a reverse order of the visuals shown to enter the immersive MR scene 106 via the window 108 are shown. In an embodiment, when the immersive MR scene 106 is dismissed, the portal object is presented by the user device 112. In an embodiment, the portal object is oriented in the same orientation that the portal object was before the immersive MR scene 106 was entered.

In an embodiment, a portal object may be within MR scenes of other portal objects. For example, a portal object may comprise a window corresponding to a mapped MR scene and a user 114 is able to enter the MR scene of the portal object after causing the user device 112 to present an immersive MR scene. During the presentation of the immersive MR scene, a second portal object (that is the same or different from the first portal object) may be presented within the immersive MR scene. In an embodiment where a portal object is presented within an immersive MR scene, a window of the virtual object may correspond to the view of the room the user 114 is in (e.g., an AR view).

FIG. 2 illustrates an example of a first view of an immersive MR scene (e.g., a first location view of immersive MR scene 202). The first location view of immersive MR scene 202 may be presented by a user device (e.g., user device 112). The immersive MR scene may be an immersive MR scene like the immersive MR scene 106 described above. In the illustrated example, the first virtual location that the view of the immersive MR scene is presented from is a virtual location behind a sink. The first location view may include a view of the immersive MR scene from the first location. In certain embodiments, a user device may be moved to cause the view of the MR scene from the first location to change. In certain embodiments, a user interface may receive input that causes the view of the MR scene from the first location to change.

A teleport feature can keep a user of the user device seated (e.g., for safety) while allowing them to easily move between virtual locations within the immersive MR scene. The teleport feature can enable virtual locations to be moved between without a user device needing to move between different physical locations. Enabling virtual locations to be moved between without physical movement of the user device can improve safety for the device and users of the user device. Additionally, the teleport feature can offer a seamless way to explore different areas of the immersive MR scene without requiring the user to stand or physically move (e.g., for convenience and/or safety).

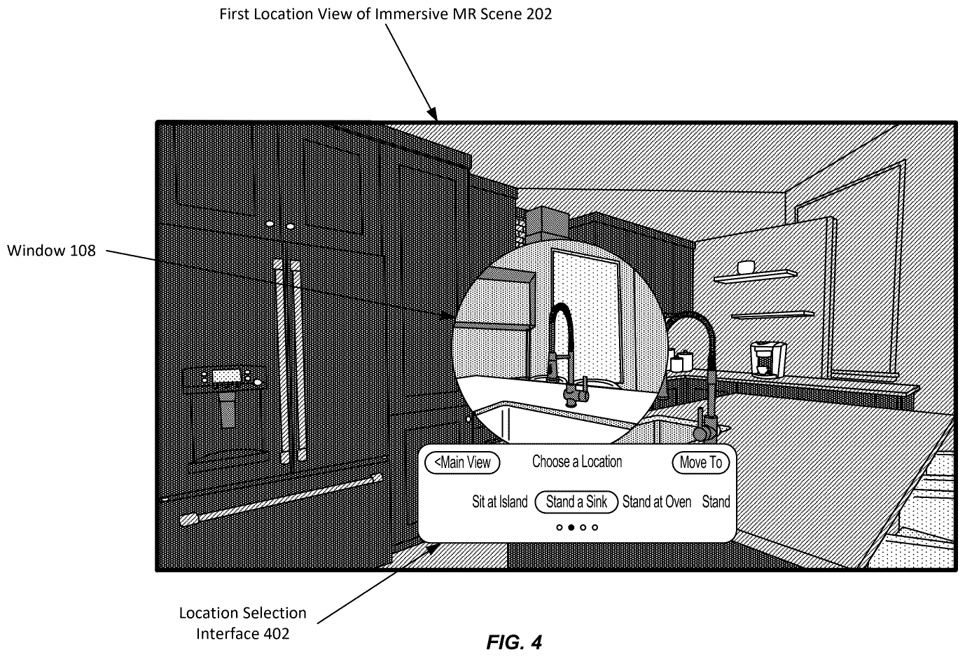

In certain embodiments, when entering an immersive MR scene for the first time during a session, a tooltip may appear above a teleport interface 204 (e.g., a software button) and indicate how to use the teleport interface 204 and/or where the teleport interface 204 is located. The teleport interface 204 is illustrated in the example shown by FIG. 2. The teleport interface 204 can be interacted with (e.g., selected) to cause a teleport preview mode to be presented. The teleport preview mode is described in further detail with respect to FIG. 4.

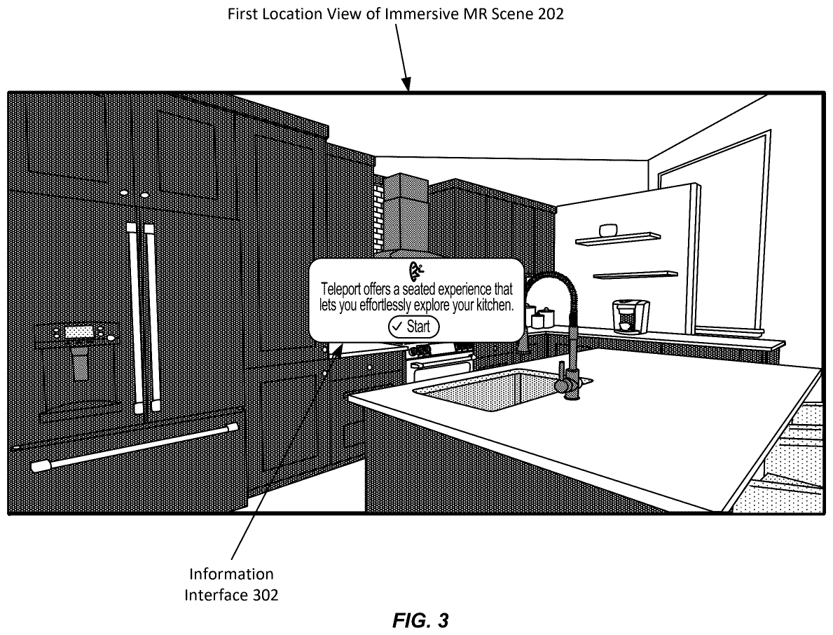

FIG. 3 illustrates an example of text that may be presented by a user interface (e.g., information interface 302) before presentation of a teleport scene navigation feature (e.g., a window, a portal object). The information interface 302 may be presented after a first location view of the first immersive MR scene 202 is presented and/or while at least a portion of the first location view of the first immersive MR scene 202 is presented. The text may be presented after the teleport interface 204 described above is interacted with. The text may be presented before presenting a teleport preview mode and may provide guidance for changing virtual locations in an immersive MR scene via use of a portal and/or a window presented using the teleport preview mode. The information interface may be presented while the first location view of an immersive MR scene 202 is being presented by the user device.

FIG. 4 illustrates an example of a portal object including a window 108 (e.g., window 108 described above) that may be presented by a user device (e.g., user device 112). The window may be presented after or in combination with a location selection interface 402. The location selection interface 402 may indicate a virtual location that the immersive MR scene presented within the window 108 is being viewed from. The location selection interface 402 can be used to change the viewing location represented by the window 108.

In the illustrated example, the portal object may be a planar circle object or a three-dimensional (3D) cylinder object. The window 108 may be presented on a surface of the portal object. The window 108 may be presented within the immersive MR scene. The window 108 may be presented at an absolute virtual location or a virtual location relative to the virtual viewing location. The window 108 may be presented at a virtual location within the immersive MR scene and may be viewed from a first location (e.g., a first location view of the immersive MR scene 202). The window 108 of the portal object may show an MR scene. The MR scene may be a different MR scene than the immersive MR scene that includes the window 108.

The MR scene may be the same MR scene as the immersive MR scene that includes the window 108. In embodiments where the same MR scene is being presented by the window 108, the MR scene may be a duplicate instantiation of the MR scene that the window 108 is presented within. The MR scene presented within the window 108 may be the MR scene the user device is currently presenting outside of the window 108, but from a different virtual location within the MR scene. For example, as described above with respect to FIG. 3, the user device may present the MR scene from a virtual location behind a sink. The window 108 may include options for other virtual locations the user device may view the MR scene from (e.g., standing at the sink, sitting at an island, standing at an oven, etc.). The other virtual locations to choose from may be user configurable and/or predefined.

The MR scene displayed within the portal may be a different instance (e.g., a copy of) of the first MR scene presented outside of the window 108. The window 108 may enable a user device to present a different viewing angle of one or more items within the MR scene.

The portal object and/or window 108 may present the MR scene from a virtual location based on a selected virtual location. The virtual location may be selected from a list of options (e.g., a rotating carousel). The selected virtual location may be presented within the window 108 and act as a preview of the MR scene associated with the virtual location viewed from the respective virtual location. The respective virtual location of the MR scene previewed within the window 108 may be entered (e.g., caused to be an immersive MR scene by being further selected via an action (e.g., a pinching gesture, a button press, a voice command, and/or interacting with a “move to” button, etc.).

After the window 108 is entered, the user device may present an immersive MR scene from the virtual location presented by the window 108. The above can occur without movement of the user device. The window 108 and/or the MR scene objects within the window 108 may move toward the user as the portal opens and scales up, transitioning into the immersive MR scene (e.g., transitioning to a second location view of the immersive MR scene), but from a different virtual location than presented before the window 108 was entered. Nausea and other adverse effects can be reduced or prevented by changing virtual location using the techniques described herein.

In certain embodiments, after entering a portal object and/or window 108, one or more other windows and/or portal objects may be presented within the entered MR scene. In certain embodiments, the portal objects and/or windows are not persistent in the MR scene and appear after a user interface element (e.g., a teleport interface 204) is interacted with. The presence of the portal objects and/or windows may be toggled on and off using the teleport interface.

In certain embodiments, after entering a portal object and/or window 108, the portal object and/or window 108 can be exited back through and cause the first location view of the immersive MR scene 202 to be presented. In certain embodiments, after entering a portal object and/or window 108, the location view of the MR scene can be changed back/reverted by interacting with an interface element such as a back button. In certain embodiments, a window 108 can be presented by the user device for further changing the virtual location from which the MR scene is displayed from.

In certain embodiments, the window is presented at a predefined virtual location within the MR scene. In certain embodiments, the window is presented at a predefined virtual location relative to the virtual location of the user device view. In certain embodiments, only one window and/or portal object are presented in the MR scene at a single time. In certain embodiments, the window is presented at a predefined virtual location within the MR scene. In certain embodiments, the portal object is presented at a specific location of a display which is independent of a virtual location in the MR scene.

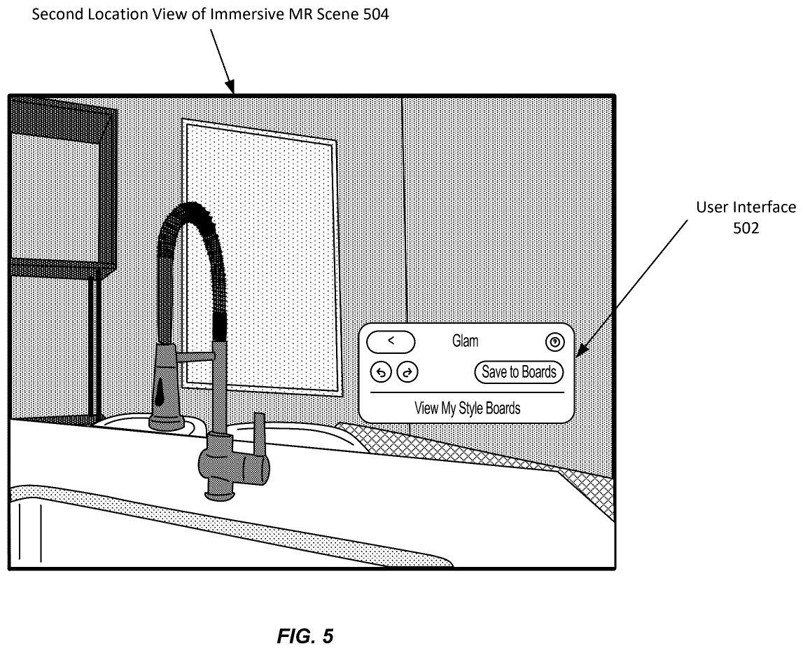

FIG. 5 illustrates an example of a MR scene (e.g., the MR scene shown by the first location view of immersive MR scene 202 described above) viewed from a second virtual location (e.g., second location view of immersive MR scene 504) that may be presented by a user device (e.g., user device 112). The example shows that the “stand at sink” option was selected for moving to using the user interface presented in FIG. 4, causing the MR scene that was originally presented from a first virtual location to be presented from a second virtual location in front of the sink, as if the sink was being stood in front of. As described above, the sink may be the same sink as presented from the first virtual location, even if the second MR scene is a different instance of the first MR scene that presented the sink from the first virtual location. Any edits (e.g., change in texture, material, color, shape, etc.) made to the sink may carry over between the first virtual location and the second virtual location viewing location regardless of whether the first MR scene used to present the first virtual location and the second MR scene used to present the second virtual location are the same MR scene instance or not.

A user interface may be presented by the user device that provides an option to go back to a previous virtual viewing location. For example, the MR scene may be presented from a first virtual location, then a second virtual location, and then a third virtual location over time. The back button of the user interface 502 may enable the MR scene to be presented from the second location again. Subsequently, a forward button of the user interface 502 may be interacted with to cause the MR scene to be presented from the third virtual location again. In certain embodiments, whether transitioning between virtual locations using a portal object or another interface elements (e.g., user interface 502), animation(s) may be presented to represent movement between the virtual locations. The animations may show a window being moved into or backed out of.

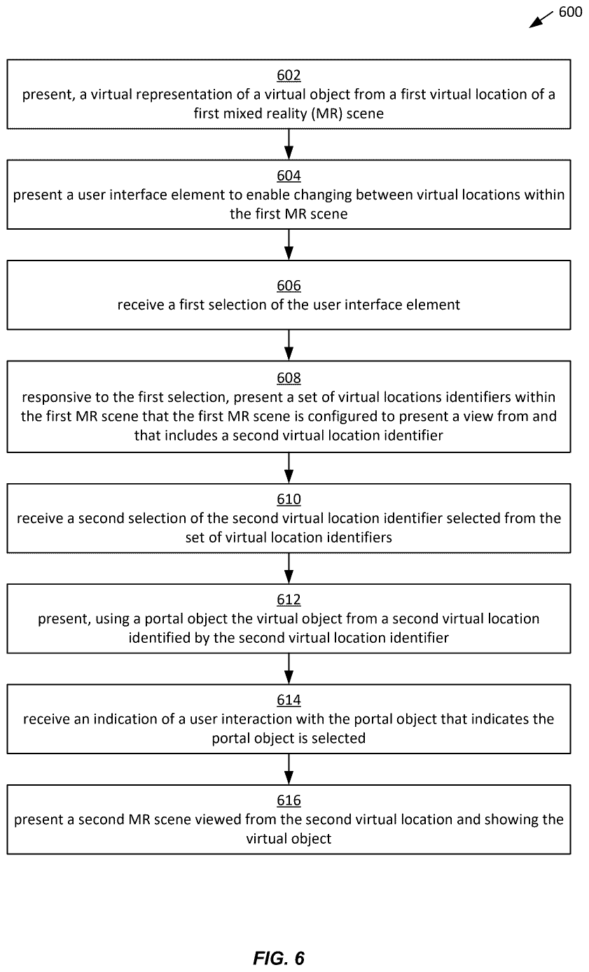

FIG. 6 illustrates a method 600 of interacting with a portal object window, according to certain embodiments disclosed herein. As an example, interacting with the portal object may include at least entering an MR scene (e.g., an immersive MR scene) represented by a window of the portal object. Method 600 can be performed by a user device (e.g., user device 112).

At 602, the user device can present, a virtual representation of a virtual object from a first virtual location of a first mixed reality (MR) scene. For example, see the presentation shown in FIG. 2.

At 604, the user device may present a user interface element to enable changing between virtual locations within the first MR scene. For example, see the presentation shown in FIG. 2.

At 606, the user device may receive a first selection of the user interface element. For example, the teleport interface 204 illustrated in FIG. 2 may be selected.

At 608, the suer device may, responsive to the first selection, present a set of virtual locations identifiers within the first MR scene. The first MR scene may be configured to present a view from the virtual locations identified by the set of virtual location identifiers. The set of virtual location identifiers may include a second virtual location identifier. For example, see the presentation of the location selection interface 402 shown in FIG. 4.

At 610, the user device may receive a second selection of the second virtual location identifier selected from the set of virtual location identifiers. For example, the “stand at sink” option from the location selection interface 402 shown in FIG. 4 may be indicated be indicated by the user interface as being selected.

At 612, the user device may present, using a portal object, the virtual object from a second virtual location identified by the second virtual location identifier. For example, see FIG. 4 portal presentation of sink.

At 614, the user device may receive an indication of an interaction with the portal object that indicates the portal object is selected. For example, a “move to” interface element of FIG. 4 may be selected or a reverse pinching gesture may be detected.

At 616, the user device may present a second MR scene viewed from the second virtual location and showing the virtual object. For example, the interface of FIG. 5 may be presented.

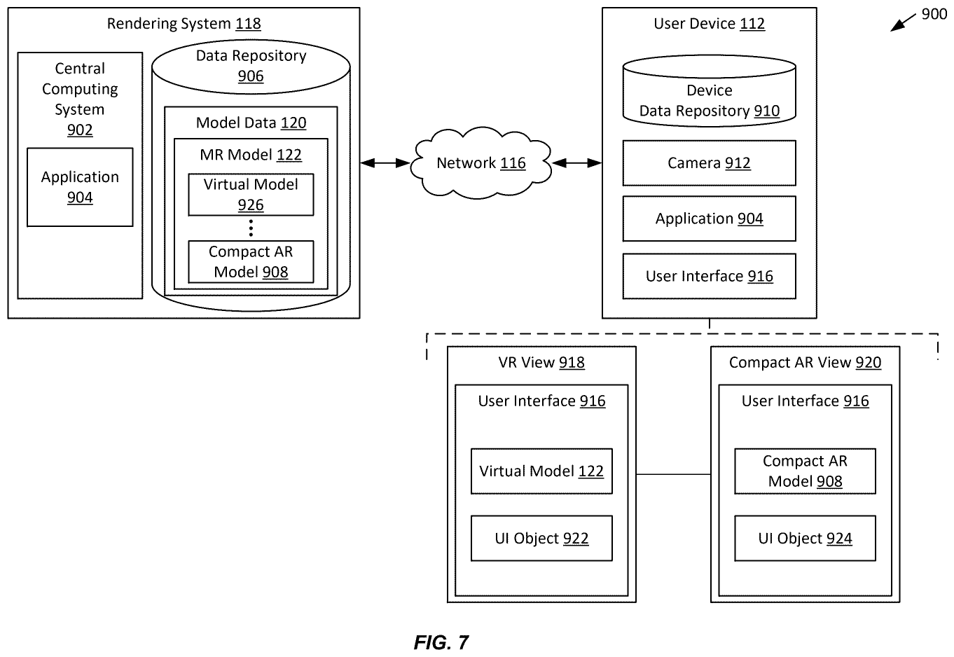

FIG. 7 depicts further details of the computing environment of FIG. 1, according to certain embodiments disclosed herein.

Elements that are found in FIG. 1 are further described in FIG. 7 and referred thereto using the same element numbers. In certain embodiments, the rendering system 118 includes a central computing system 902, which supports an application 904. The application 904 could be a mixed reality application. For example, the mixed reality may include an augmented reality (“AR”) and/or a virtual reality (“VR”). The application 904 enables a presentation of a MR model 122 (e.g., a compact AR model 908 and/or a virtual model 926 of the physical environment in a compact AR view 920 and/or VR view 918, respectively). The application 904 may be accessed by and executed on a user device 112 associated with a user of one or more services of the rendering system 118. For example, the user may access the application 904 via a web browser application of the user device 112. In other examples, the application 904 is provided by the rendering system 118 for download on the user device 112. As depicted in FIG. 7, the user device 112 communicates with the central computing system 902 via the network 116. Although a single user device 112 is illustrated in FIG. 7, the application 904 can be provided to (or can be accessed by) multiple user devices 112. Further, although FIG. 7 depicts a rendering system 118 that is separate from the user device 112 and that communicates with the user device 112 via the network 116, in certain embodiments the rendering system 118 is a component of the user device 112 and the functions described herein as being performed by the rendering system 118 are performed on the user device 112.

In certain embodiments, the rendering system 118 comprises a data repository 906. The data repository 906 could include a local or remote data store accessible to the central computer system 902. In some instances, the data repository 906 is configured to store the model data 120 defining the MR model 122 (e.g., the compact AR model 908, a virtual model 926). The model data 120 may comprise portal object data, window data, mapping data, and/or MR scene data. A compact AR model 908 may be associated with the virtual model 926.

As shown in FIG. 7, the user device 112 comprises, in some instances, a device data repository 910, a camera 912, the application 904, and a user interface 916. The device data repository 910 could include a local or remote data store accessible to the user device 112. The camera 912 communicates with the application 904. The camera 912 is capable of capturing a field of view as depicted in FIG. 1. The user interface 916 enables the user of the user device 112 to interact with the application 904 and/or the rendering system 118. The user interface 916 could be provided on a display device (e.g., a display monitor), a touchscreen interface, or other user interface that can present one or more outputs of the application 904 and/or rendering system 118 and receive one or more inputs of the user of the user device 112. The user interface 916 can include a MR view which can present a MR model 122 within the MR view. As an example, a compact AR view 920 can present the compact AR model 908 within the compact AR view 920.

The user interface 916 can also display a user interface (UI) object 924 in a MR view, such as the compact AR view 920. Responsive to detecting a selection of the UI object 924, the rendering system 118 may change the MR model 122 being presented. For example, responsive to detecting a selection of the UI object 924, the rendering system 118 may cease displaying the compact AR view 920 that includes the compact AR model 908 and begin displaying a VR view 918 including the virtual model 926 (which may be associated with the compact AR model 908). In some embodiments, UI object 924 selection causes the rendering system 118 to change a portion of a MR scene, window, and/or portal object that is being presented.

The user interface 916 can also display a user interface (UI) object 922 in a VR view 918, for example. Responsive to detecting a selection of the UI object 922, the rendering system 118 can cease displaying the VR view 918 that includes the virtual model 926 and begin displaying a different MR view (e.g., the compact AR view 920 including the compact AR model 908 (which may be associated with the virtual model 926)). In some embodiments, UI object 924 selection causes the rendering system 118 to change a portion of a MR scene, window, and/or portal object that is being presented.

Thus, in some embodiments, the rendering system 118 may alternate between displaying, via the user interface 916, the VR view 918 and the compact AR view 920 responsive to detecting selection of the UI object 922 and UI object 924. In some embodiments, when an immersive MR scene is being presented by the user device 112, a compact AR view 920 or a VR view 918 is being displayed via the user interface 916. In some embodiments, a VR view 918 is used to display a portal object via the user interface 916.

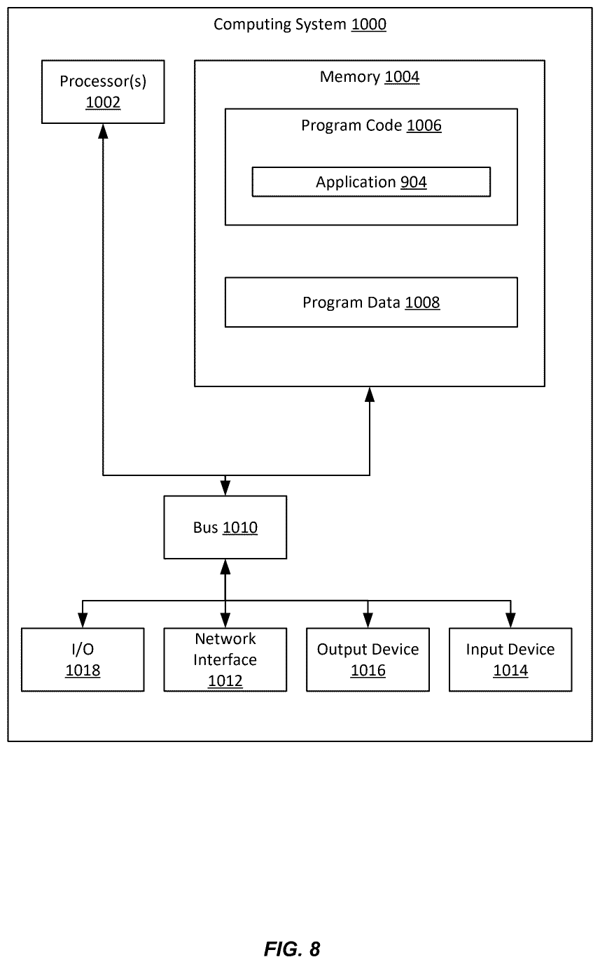

Any suitable computer system or group of computer systems can be used for performing the operations described herein. For example, FIG. 8 depicts an example of a computing system 1000. The depicted example of the computing system 1000 includes a processor 1002 communicatively coupled to one or more memory devices 1004. The processor 1002 executes computer-executable program code stored in a memory device 1004, accesses information stored in the memory device 1004, or both. Examples of the processor 1002 include a microprocessor, an application-specific integrated circuit (“ASIC”), a field-programmable gate array (“FPGA”), or any other suitable processing device. The processor 1002 can include any number of processing devices, including a single processing device.

The memory device 1004 includes any suitable non-transitory computer-readable medium for storing program code 1006, program data 1008, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 1004 can be volatile memory, non-volatile memory, or a combination thereof.

The computing system 1000 executes program code 1006 that configures the processor 1002 to perform one or more of the operations described herein. Examples of the program code 1006 include, in various embodiments, the rendering system 118 and subsystems thereof (which may include a location determining subsystem, a mixed reality rendering subsystem, and/or a model data generating subsystem) of FIG. 1, which may include any other suitable systems or subsystems that perform one or more operations described herein (e.g., one or more neural networks, encoders, attention propagation subsystem and segmentation subsystem). The program code 1006 may be resident in the memory device 1004 or any suitable computer-readable medium and may be executed by the processor 1002 or any other suitable processor.

The processor 1002 is an integrated circuit device that can execute the program code 1006. The program code 1006 can be for executing an operating system, an application system or subsystem, or both. When executed by the processor 1002, the instructions cause the processor 1002 to perform operations of the program code 1006. When being executed by the processor 1002, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 1004 store the program data 1008 that includes one or more datasets described herein. In some embodiments, one or more of data sets are stored in the same memory device (e.g., one of the memory devices 1004). In additional or alternative embodiments, one or more of the programs, data sets, models, and functions described herein are stored in different memory devices 1004 accessible via a data network. One or more buses 1010 are also included in the computing system 1000. The buses 1010 communicatively couple one or more components of a respective one of the computing system 1000.

In some embodiments, the computing system 1000 also includes a network interface device 1012. The network interface device 1012 includes any device or group of devices suitable for establishing a wired or wireless data connection to one or more data networks. Non-limiting examples of the network interface device 1012 include an Ethernet network adapter, a modem, and/or the like. The computing system 1000 is capable of communicating with one or more other computing devices via a data network using the network interface device 1012.

The computing system 1000 may also include a number of external or internal devices, an input device 1014, a presentation device 1016, or other input or output devices. For example, the computing system 1000 is shown with one or more input/output (“I/O”) interfaces 1018. An I/O interface 1018 can receive input from input devices or provide output to output devices. An input device 1014 can include any device or group of devices suitable for receiving visual, auditory, or other suitable input that controls or affects the operations of the processor 1002. Non-limiting examples of the input device 1014 include a touchscreen, a mouse, a keyboard, a microphone, a separate mobile computing device, etc. A presentation device 1016 can include any device or group of devices suitable for providing visual, auditory, or other suitable sensory output. Non-limiting examples of the presentation device 1016 include a touchscreen, a monitor, a speaker, a separate mobile computing device, etc.

Although FIG. 8 depicts the input device 1014 and the presentation device 1016 as being local to the computing system 1000, other implementations are possible. For instance, in some embodiments, one or more of the input device 1014 and the presentation device can include a remote client-computing device (e.g., user device 112) that communicates with computing system 1000 via the network interface device 1012 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

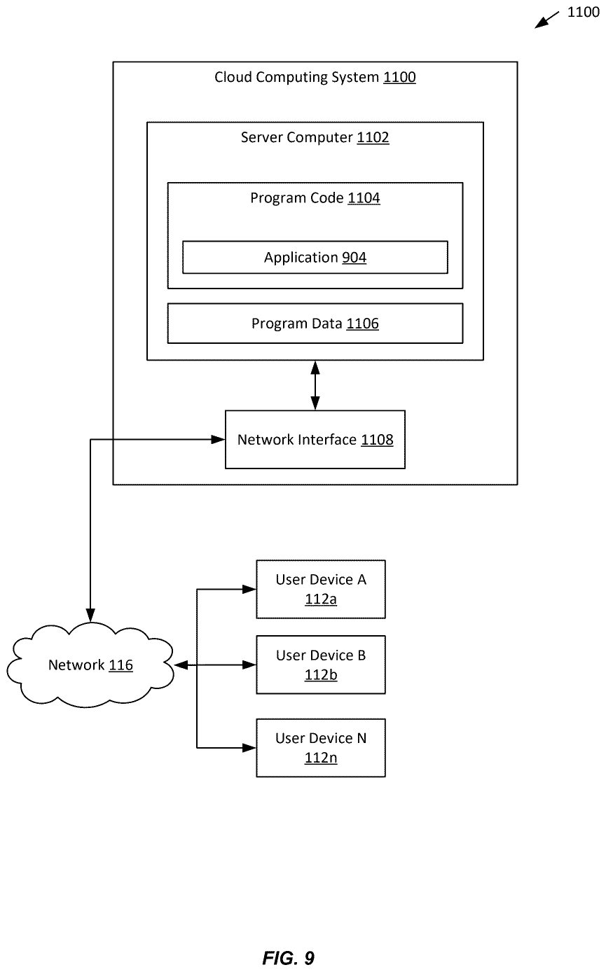

In some embodiments, the functionality provided by computing system 1000 may be offered as cloud services by a cloud service provider. For example, FIG. 9 depicts an example of a cloud computing system 1100 offering a service for providing MR models 122 (e.g., compact AR models 908 for generating mixed reality views of a physical environment and/or offering a service for providing virtual models 926 for generating mixed reality views of a physical environment). In the example, the service for providing MR models 122 (e.g., compact AR models 908, virtual models 926) for generating mixed reality views of a physical environment may be offered under a Software as a Service (SaaS) model. One or more users may subscribe to the service for to provide MR models 122 for generating mixed reality views of a physical environment and the cloud computing system 1100 performs the processing to provide MR models 122 for generating mixed reality views of a physical environment. The cloud computing system 700 may include one or more remote server computers 708.

The remote server computers 1102 include any suitable non-transitory computer-readable medium for storing program code 1104 and program data 1106, or both, which is used by the cloud computing system 1100 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 1102 can include volatile memory, non-volatile memory, or a combination thereof. One or more of the server computers 1102 execute the program code 1104 that configures one or more processors of the server computers 1102 to perform one or more of the operations that provide MR models 122 (e.g., compact AR models 908 and/or virtual models 926) for generating mixed reality views of a physical environment.

As depicted in the embodiment in FIG. 9, the one or more servers providing the services for providing MR models 122 (e.g., compact AR models 908, virtual models 926) for generating mixed reality views of a physical environment may implement the rendering system 118 central computing system 902, and the application 904. Any other suitable systems or subsystems that perform one or more operations described herein (e.g., one or more development systems for configuring an interactive user interface) can also be implemented by the cloud computing system 1100.

In certain embodiments, the cloud computing system 1100 may implement the services by executing program code and/or using program data 1106, which may be resident in a memory device of the server computers 1102 or any suitable computer-readable medium and may be executed by the processors of the server computers 1102 or any other suitable processor.

In some embodiments, the program data 1106 includes one or more datasets and models described herein. In some embodiments, one or more of data sets, models, and functions are stored in the same memory device. In additional or alternative embodiments, one or more of the programs, data sets, models, and functions described herein are stored in different memory devices accessible via the data network 116.

The cloud computing system 1100 also includes a network interface device 1108 that enable communications to and from cloud computing system 1100. In certain embodiments, the network interface device 1108 includes any device or group of devices suitable for establishing a wired or wireless data connection to the data networks 116. Non-limiting examples of the network interface device 1108 include an Ethernet network adapter, a modem, and/or the like. The service for providing MR models 122 for generating mixed reality views of a physical environment is capable of communicating with any number of user devices, as represented by the user devices 112a, 112b, through 112n via the data network 116 using the network interface device 1108.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A user device, the user device comprising:
one or more processors; and
one or more memory storing instructions that, upon execution by the one or more processors, configure the user device to:
present, a virtual representation of a virtual object from a first virtual location of a first mixed reality (MR) scene;
present a user interface element to enable changing between virtual locations within the first MR scene;
receive a first selection of the user interface element;
responsive to the first selection, present a set of virtual locations identifiers within the first MR scene that the first MR scene is configured to present a first view from and that includes a second virtual location identifier;
receive a second selection of the second virtual location identifier selected from the set of virtual location identifiers;
present, using a portal object, the virtual object from a second virtual location identified by the second virtual location identifier;
receive an indication of an interaction with the portal object that indicates the portal object is selected; and
present the first MR scene viewed from the second virtual location and showing the virtual object.

2. The user device of claim 1, wherein presenting the first MR scene viewed from the second virtual location includes presenting a second MR scene that is generated based on the first MR scene.

3. The user device of claim 1, wherein the first virtual location and the second virtual location are viewed from a common physical location of the user device.

4. The user device of claim 1, wherein receiving the indication of the interaction with the portal object is based at least in part on the user device detecting a reverse pinching gesture.

5. The user device of claim 1, wherein the portal object includes a first window that presents the virtual object from the second virtual location and a second window that presents the virtual object from a third virtual location.

6. The user device of claim 5, wherein receiving the indication of the interaction with the portal object further configures the user device to receive a second indication of a second interaction with the first window.

7. The user device of claim 1, wherein the execution of the instructions further configures the user device to:
present a second user interface element to enable changing between virtual locations within the first MR scene;
receive a third selection of the second user interface element; and
responsive to the third selection, present a second set of virtual locations identifiers within the first MR scene that the first MR scene is configured to present a second view from and that includes a third virtual location identifier.

8. The user device of claim 7, wherein the execution of the instructions further configures the user device to:
receive a fourth selection of the third virtual location identifier selected from the second set of virtual location identifiers;
present, using a second portal object, the virtual object from a third virtual location identified by the third virtual location identifier;
receive a second indication of a second interaction with the second portal object that indicates the second portal object is selected; and
present the first MR scene viewed from the third virtual location and showing the virtual object.

9. The user device of claim 1, wherein the execution of the instructions further configures the user device to:
present a second user interface element to enable changing between virtual locations within the first MR scene;
receive a third selection of the second user interface element; and
present the first MR scene viewed from the first virtual location and showing the virtual object.

10. The user device of claim 1, wherein the execution of the instructions further configures the user device to:
responsive to detecting, using a camera, a gesture: present the first MR scene viewed from the first virtual location and showing the virtual object.

11. The user device of claim 1, wherein the execution of the instructions further configures the user device to:
receive, after presenting the first MR scene viewed from the second virtual location, a second indication to change a visual property of the first MR scene; and
after the second indication, present the first MR scene viewed from the first virtual location and showing the change to the visual property of the first MR scene.

12. A method comprising:
presenting, a virtual representation of a virtual object from a first virtual location of a first mixed reality (MR) scene;
presenting a user interface element to enable changing between virtual locations within the first MR scene;
receiving a first selection of the user interface element;
responsive to the first selection, presenting a set of virtual locations identifiers within the first MR scene that the first MR scene is configured to present a first view from and that includes a second virtual location identifier;
receiving a second selection of the second virtual location identifier selected from the set of virtual location identifiers;
presenting, using a portal object, the virtual object from a second virtual location identified by the second virtual location identifier;
receiving an indication of an interaction with the portal object that indicates the portal object is selected; and
presenting the first MR scene viewed from the second virtual location and showing the virtual object.

13. The method of claim 12, wherein the first virtual location and the second virtual location are viewed from a common physical location of a user device presenting the first MR scene.

14. The method of claim 12, wherein receiving the indication of the interaction with the portal object is based at least in part on a user device detecting a reverse pinching gesture.

15. The method of claim 12, wherein the portal object includes a first window that presents the virtual object from the second virtual location and a second window that presents the virtual object from a third virtual location.

16. The method of claim 12, further comprising:
present a second user interface element to enable changing between virtual locations within the first MR scene;
receive a third selection of the second user interface element; and
responsive to the third selection, present a second set of virtual locations identifiers within the first MR scene that the first MR scene is configured to present a second view from and that includes a third virtual location identifier.

17. One or more non-transitory computer-readable storage media storing instructions that, upon execution by one or more processors of a system, cause the system to perform operations comprising:
presenting, a virtual representation of a virtual object from a first virtual location of a first mixed reality (MR) scene;
presenting a user interface element to enable changing between virtual locations within the first MR scene;
receiving a first selection of the user interface element;
responsive to the first selection, presenting a set of virtual locations identifiers within the first MR scene that the first MR scene is configured to present a first view from and that includes a second virtual location identifier;
receiving a second selection of the second virtual location identifier selected from the set of virtual location identifiers;
presenting, using a portal object, the virtual object from a second virtual location identified by the second virtual location identifier;
receiving an indication of an interaction with the portal object that indicates the portal object is selected; and
presenting the first MR scene viewed from the second virtual location and showing the virtual object.

18. The computer-readable storage media of claim 17, wherein the execution of the instructions further cause the system to:
present a second user interface element to enable changing between virtual locations within the first MR scene;
receive a third selection of the second user interface element; and
present the first MR scene viewed from the first virtual location and showing the virtual object.

19. The computer-readable storage media of claim 17, wherein the execution of the instructions further cause the system to:
responsive to detecting, using a camera, a gesture: present the first MR scene viewed from the first virtual location and showing the virtual object.

20. The computer-readable storage media of claim 17, wherein the execution of the instructions further cause the system to:
receive, after presenting the first MR scene viewed from the second virtual location, a second indication to change a visual property of the first MR scene; and
after the second indication, present the first MR scene viewed from the first virtual location and showing the change to the visual property of the first MR scene.
